(19) United States
(12) Patent Application Publication
(10) Pub. No.: US 2026/0158795 A1
(43) Pub. Date: Jun. 11, 2026

(54) INK CONTAINER

(71) Applicant: CANON KABUSHIKI KAISHA, Tokyo (JP)

(72) Inventor: NAOYA TSUKAMOTO, Kanagawa (JP)

(21) Appl. No.: 19/349,769

(22) Filed: Oct. 3, 2025

(30) Foreign Application Priority Data
Oct. 8, 2024 (JP) 2024-176514

(51) Int. Cl. B41J 2/175; B32B 27/10; B32B 27/32

(52) U.S. Cl. CPC B41J 2/17553; B32B 27/10; B32B 27/32; B32B 2250/02; B32B 2307/7376

(57) ABSTRACT

An ink container includes an ink containing unit provided with flexibility so as to be able to contain an ink inside, and an ink supply unit configured to supply the ink contained inside the ink containing unit to outside. The ink containing unit is formed by using a film member having breaking elongation equal to or above 1%. The film member includes an internal layer being formed by using an olefin-based resin and surrounding the inside of the ink containing unit, and an external layer formed on an outer side of the internal layer by using paper. A viscosity of the ink contained inside the ink containing unit is equal to or above 2 (mPa·s) and equal to or below 3 (mPa·s). A weight ratio of the paper of the external layer relative to the ink container is equal to or above 50%.

### BACKGROUND

### Field of the Technology

The present disclosure relates to an ink container.

### Description of the Related Art

An ink jet printer forms characters, images, and the like by ejecting inks from an ink ejection head to a print medium, for example. In recent years, ink jet printers have been used not only as home printers as well as office printers, but also as industrial printers. There is an ink jet printer designed to use an ink contained in an ink container in the form of a bag by supplying the ink to an ink ejection head.

There has been a demand in recent years for product development to reduce burdens on the global environment. One example of a method of reducing a burden on the global environment is to fabricate ink containers by using paper. The use of paper for the ink containers can reduce the amount of use of plastics so as to reduce burdens on the global environment associated with disposal of plastic wastes. For example, Japanese Patent Laid-Open No. 2014-184664 discloses a technique that enables suppression of detachment of a joined portion of a paper material in an ink container including an ink containing unit formed by using a paper material.

### SUMMARY

An object of the present disclosure is to provide an ink container which makes it possible to stably use up an ink while reducing a burden on the global environment.

An ink container according to an aspect of the present disclosure includes an ink containing unit provided with flexibility so as to be able to contain an ink inside, and an ink supply unit configured to supply the ink contained inside the ink containing unit to outside. The ink containing unit is formed by using a film member having breaking elongation equal to or above 1%. The film member includes an internal layer being formed by using an olefin-based resin and surrounding the inside of the ink containing unit, and an external layer formed on an outer side of the internal layer by using paper. A viscosity of the ink contained inside the ink containing unit is equal to or above 2 [mPa·s] and equal to or below 3 [mPa·s]. A weight ratio of the paper of the external layer relative to the ink container is equal to or above 50%.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic perspective view of an ink ejection apparatus.

FIGS. 2A and 2B are schematic diagrams showing an ink container according to a first embodiment.

FIG. 3 is a schematic diagram showing a film member.

FIG. 4 is a schematic diagram showing an ink container according to a third embodiment.

FIG. 5 is a schematic diagram showing a modified example of the ink container according to the third embodiment.

FIG. 6 is a schematic diagram showing an ink container according to a fourth embodiment.

FIG. 7 is an explanatory diagram to explain a maximum value of a curvature radius of a curved portion.

FIG. 8 is a schematic diagram showing a first modified example of the ink container according to the fourth embodiment.

FIG. 9 is a schematic diagram showing a second modified example of the ink container according to the fourth embodiment.

FIG. 10 is a schematic diagram showing a third modified example of the ink container according to the fourth embodiment.

### DESCRIPTION OF THE EMBODIMENTS

Preferred embodiments of the present disclosure will be described below in detail with reference to the accompanying drawings. It is to be noted that the following embodiments are not intended to limit the matters pertaining to the present disclosure, and that all of the combination of the features described in the following embodiments is not always essential for a solution of the present disclosure. Here, the same constituents will be denoted by the same reference signs and will be explained accordingly.

### First Embodiment

The technologies described in this specification have the potential to contribute to the achievement of a sustainable society, such as a decarbonized society/circular society. Along with expansion in usage of ink jet printers, ink containers also face demands for not only small capacity ink containers for home use but also large capacity ink containers for office or industrial use. In an ink container in which an ink containing unit is formed by using paper, an amount of use of the paper can be reduced more as the paper used for the ink containing unit is thinner. However, mechanical strength such as rigidity of the ink containing unit and recoverability of a form of the ink containing unit will be deteriorated instead. As a consequence, irregular deformation inherent in thin paper as well as fine and deep wrinkles are prone to occur in the ink containing unit, in a process of manufacturing the ink container, a process of transporting the ink container, a process of contracting the ink containing unit in a case of supplying the ink to the ink jet printer, and the like. In the case of the ink container including the ink containing unit formed by using the paper, fluidity of the ink inside the ink containing unit is deteriorated due to irregular deformation inherent in thin paper as well as fine and deep wrinkles occurring in the ink containing unit. Accordingly, it is difficult to use up the ink inside the ink containing unit. The present embodiment will describe an ink container which makes it possible to stably use up an ink while reducing a burden on the global environment.

### <Configuration of Ink Ejection Apparatus>

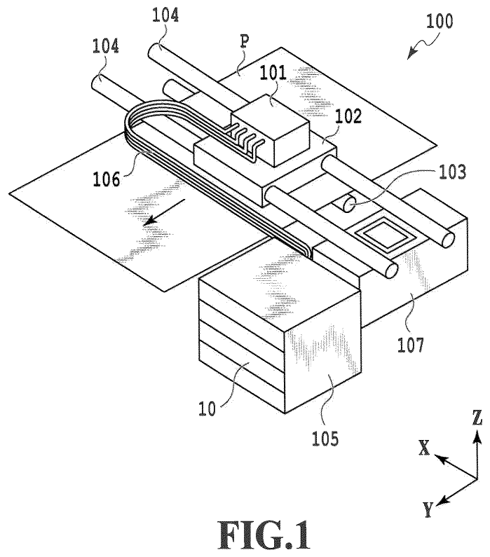

FIG. 1 is a schematic perspective view of an ink ejection apparatus 100 according to the present embodiment. As shown in FIG. 1, the ink ejection apparatus 100 includes an ink ejection head 101, a carriage 102, a conveyance roller 103, an ink supply unit 105, ink supply tubes 106, and a recovery unit 107. The ink ejection apparatus 100 repeats reciprocal movement (main scanning) of the ink ejection head 101 and conveyance (sub scanning) of a print sheet P being a print medium at a predetermined pitch each time. The ink ejection apparatus 100 selectively ejects inks in multiple colors from the ink ejection head 101 while synchronizing the main scanning and the sub scanning mentioned above and causing the inks to land on the print sheet P, thereby forming characters, symbols, images, and the like. Examples of the ink ejection apparatus 100 include an ink jet printer and the like.

Here, the print medium is not limited to the print sheet P but may be any medium that can allow landing of ink droplets so as to form images and so forth. For example, it is possible to use print media of various materials and various forms including paper, cloth, optical disc labels, plastic sheets, OHP sheets, envelops, and the like. Meanwhile, in the respective drawings to be hereinafter referred to, Z direction represents a vertical direction which intersects (at right angle in the case of the present embodiment) with X-Y plane that is defined by X direction and Y direction.

The ink ejection head 101 is detachably mounted on the carriage 102. The carriage 102 is supported by two guide rails 104 in such a way as to be slidable in the X direction. The carriage 102 that mounts the ink ejection head 101 reciprocally moves on a straight line along the guide rails 104 by using a drive unit (not shown) such as a motor.

The print sheet P is conveyed in a direction intersecting with a direction of movement of the carriage 102, or more specifically, in a direction (the Y direction) orthogonal to the direction of movement of the carriage 102 by the conveyance roller 103 serving as a conveyance unit. In the case where the print sheet P is conveyed by the conveyance roller 103, the print sheet P is opposed to an ink ejection unit (not shown) of the ink ejection head 101. Ink droplets ejected from the ink ejection unit of the ink ejection head 101 land on the print sheet P opposed to the ink ejection unit of the ink ejection head 101.

The ink ejection head 101 includes multiple nozzle arrays which serve as multiple ink ejection units for ejecting the inks in different colors from one another. Multiple independent ink containers 10 are attached to the ink supply unit 105 so as to correspond to the inks in multiple colors to be ejected from the ink ejection head 101. Each ink container 10 is detachably attached to the ink supply unit 105 of the ink ejection apparatus 100.

The ink supply unit 105 is connected to the ink ejection head 101 by using the multiple ink supply tubes 106 that correspond to the inks in the multiple colors. Attachment of the ink containers 10 to the ink supply unit 105 makes it possible to independently supply the inks in the respective colors contained inside the ink containers 10 to the respective nozzle arrays of the ink ejection head 101. As described above, the ink ejection apparatus 100 has a function to eject the inks supplied from the ink containers 10.

The recovery unit 107 is provided in a non-printing region which is a region within a range of reciprocal movement of the ink ejection head 101 and a region outside a range of passage of the print sheet P. The recovery unit 107 is disposed at a position opposed to the ink ejection unit (not shown) of the ink ejection head 101 having moved to the aforementioned non-printing region. The recovery unit 107 includes a cap portion, a suction mechanism, a cleaning blade, and the like.

The cap portion of the recovery unit 107 is a member for capping the ink ejection unit of the ink ejection head 101. The suction mechanism of the recovery unit 107 is a mechanism for forcibly suctioning the inks in the state of capping the ink ejection unit of the ink ejection head 101. The cleaning blade of the recovery unit 107 is a member for wiping off stains at the ink ejection unit of the ink ejection head 101. Recovery processing such as capping with the capping unit of the recovery unit 107 and suctioning of the inks with the suction mechanism thereof is carried out prior to an ejecting operation of the ink ejection apparatus 100. Even in a case where the ink ejection apparatus 100 is operated after having been suspended for a long time, it is possible to remove bubbles remaining in the ink ejection unit of the ink ejection head 101, the inks with increased viscosities in the vicinity of ejection orifices of the ink ejection head 101, and the like by carrying out the recovery processing with the recovery unit 107. Thus, ejection characteristics of the ink ejection head 101 are maintained.

### <Configuration of Ink Container>

Next, the ink containers 10 according to the first embodiment will be explained. As described above, the multiple independent ink containers 10 are attached to the ink supply unit 105 so as to correspond to the inks in the multiple colors to be ejected from the ink ejection head 101. The respective ink containers 10 are detachably attached to the ink supply unit 105. The respective ink containers 10 basically have the same configuration.

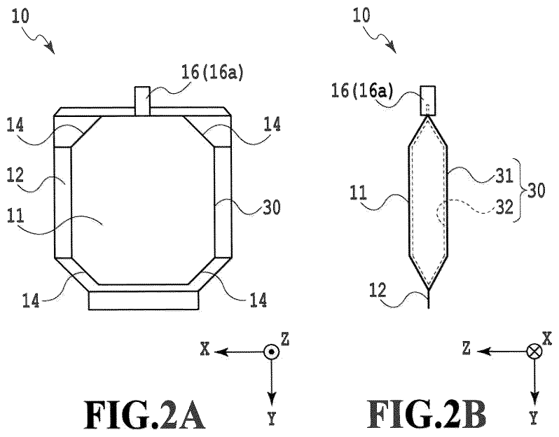

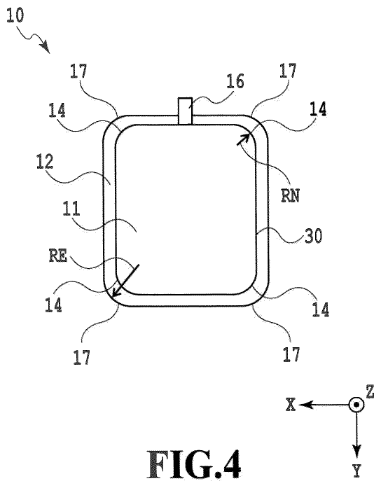

FIGS. 2A and 2B are schematic diagrams showing an ink container 10 according to the first embodiment. FIG. 2A is a plan view schematically showing the ink container 10. FIG. 2B is a side view schematically showing the ink container 10. Note that the X direction, the Y direction, and the Z direction in FIG. 2 as well as FIGS. 4 to 10 represent directions in a state where the ink container 10 is attached to the ink supply unit 105. An orientation of the ink container 10 is not limited to the orientation shown in FIG. 2 as well as FIGS. 4 to 10, and the orientation of the ink container 10 can be changed as appropriate in a state where the ink container 10 is detached from the ink supply unit 105. As shown in FIGS. 2A and 2B, the ink container 10 includes an ink containing unit 11, and an ink supply unit 16 for supplying the ink contained inside the ink containing unit 11 to the ink ejection apparatus 100 located outside.

The ink containing unit 11 is formed into a shape of a bag that can contain the ink inside. A viscosity of the ink contained inside the ink containing unit 11 is equal to or above 2 [mPa·s] and equal to or below 3 [mPa·s]. Here, the viscosity of the ink is measured with an E-type viscometer (the number of revolutions: 50 to 100 rpm) adopting a cone plate, for example. The ink containing unit 11 is formed by using a film member 30, which includes layers provided with ink resistance and gas barrier property, and has flexibility. For example, the ink containing unit 11 is formed into a shape of a gusseted bag provided with gussets at side portions by subjecting the film member 30 to a folding process and a welding process.

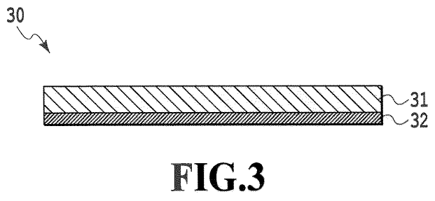

FIG. 3 is a schematic diagram showing the film member 30. As shown in FIG. 3, the film member 30 includes an external layer 31 and an internal layer 32. The external layer 31 is formed on an outer side of the internal layer 32 by using paper. A thickness of the external layer 31 is equal to 50 [μm], for example. The internal layer 32 is formed in the form of a sheet in conformity to an outer peripheral shape of the external layer 31 by using an olefin-based resin. In the present embodiment, polyethylene is used as the olefin-based resin that constitutes the internal layer 32. A thickness of the internal layer 32 is equal to 10 [μm], for example. The internal layer 32 is attached to an inner side of the external layer 31 by a lamination process. The internal layer 32 comes into contact with the ink contained inside the ink containing unit 11. Note that the film member 30 is also referred to as a laminate film. Breaking elongation of the film member 30 is equal to 1%, for example. A weight ratio of the external layer 31 in the film member 30 is larger than a weight ratio of the internal layer 32 in the film member 30. In a case where the external layer 31 is formed by using paper having a thickness of 100 [μm] and the internal layer 32 is formed by using a polyethylene film having a thickness of 10 [μm], the weight ratio of the paper of the external layer 31 relative to the ink container 10 is equal to about 88%. Here, the specific gravity of the paper is equal to 0.7 and the specific gravity of the polyethylene film is equal to 0.9. In the meantime, the weight ratio of the paper of the external layer 31 relative to the ink container 10 is equivalent to the weight ratio of the paper of the external layer 31 relative to the ink container 10 in the state where the ink is not contained inside the ink containing unit 11.

Note that rigidity of the ink container 10 may be enhanced by increasing the thickness of the external layer 31. The thickness of the external layer 31 may be equal to or above 50 [μm] and equal to or below 200 [μm]. Meanwhile, weldability of the film member 30 may be improved by increasing the thickness of the internal layer 32. The thickness of the internal layer 32 may be equal to or above 10 [μm] and equal to or below 150 [μm]. In the meantime, there is also a case where the breaking elongation of the film member 30 and the weight ratio of the paper of the external layer 31 relative to the ink container 10 vary depending on the thicknesses of the external layer 31 and the internal layer 32. The breaking elongation of the film member 30 may be equal to or above 1% and equal to or below 160%. The weight ratio of the paper of the external layer 31 relative to the ink container 10 may be equal to or above 50% and equal to or below 99.9%.

The ink supply unit 16 includes a spout member 16a made of a resin, for example. The ink supply unit 16 is formed into a tubular shape capable of connecting the ink containing unit 11 to the ink ejection apparatus 100 by welding outer peripheral portions of two film members 30 while sandwiching the spout member 16a in between. The ink container 10 takes on a form of a so-called spout pouch. The ink supply unit 16 functions as a filling port in the case of filling the inside of the ink containing unit 11 with the ink and as a connection port in the case of supplying the ink contained inside the ink containing unit 11 to the ink ejection apparatus 100. A welded portion 12 is formed on an outer peripheral side of the ink containing unit 11 by welding the outer peripheral portions of the two film members 30 to each other. A shape of the welded portion 12 is determined in accordance with a shape of a welding tool. In other words, the outer peripheral shape of the ink containing unit 11 inclusive of shapes of inner corner portions 14 formed at four corners of the ink containing unit 11 is determined in accordance with the shape of the welding tool. After formation of the ink container 10, the inside of the ink containing unit 11 is filled with the ink. Here, a pressure inside the ink containing unit 11 is reduced before being filled with the ink, and the inside of the ink containing unit 11 with the reduced pressure is filled with the deaerated ink. Thus, it is possible to eliminate the air inside the ink containing unit 11, so that generation of the air from the ink contained inside the ink containing unit 11 can be suppressed. Since no air is contained inside the ink containing unit 11 of the ink container 10 according to the present embodiment, the ink containing unit 11 in the form of the bag is contracted in accordance with a decrease with use of the ink contained inside the ink containing unit 11.

In the present embodiment, the breaking elongation of the film member 30 is preferably equal to or above 1%. The weight ratio of the paper of the external layer 31 relative to the ink container 10 is preferably equal to or above 50%. The use of more paper in the ink container 10 makes it possible to reduce an amount of use of the plastics and to reduce a burden on the global environment attributed to disposal of plastic wastes. Meanwhile, the viscosity of the ink contained inside the ink containing unit 11 is preferably equal to or above 2 [mPa·s] and equal to or below 3 [mPa·s]. By containing the ink having the relatively low viscosity, it is possible to suppress deterioration in fluidity of the ink inside the ink containing unit 11 even in the case where irregular deformation inherent in thin paper and fine and deep wrinkles occur in the ink containing unit 11. Accordingly, it is possible to stably use up the ink as compared to a case where the viscosity of the ink contained inside the ink containing unit 11 is equal to 20 [mPa·s].

As described above, the first embodiment can provide the ink container 10 which makes it possible to stably use up the ink while reducing the burden on the global environment. Specifically, in the present embodiment, the breaking elongation of the film member 30 is equal to or above 1%, and the weight ratio of the paper of the external layer 31 relative to the ink container 10 is equal to or above 50%. The use of more paper in the ink container 10 makes it possible to reduce the amount of use of the plastics and to reduce the burden on the global environment attributed to the disposal of plastic wastes. Meanwhile, the viscosity of the ink contained inside the ink containing unit 11 is equal to or above 2 [mPa·s] and equal to or below 3 [mPa·s]. By containing the ink having the relatively low viscosity, it is possible to suppress deterioration in fluidity of the ink inside the ink containing unit 11 even in the case where irregular deformation inherent in thin paper and fine and deep wrinkles occur in the ink containing unit 11. Accordingly, it is possible to stably use up the ink. In this way, the ink container 10 can be provided which makes it possible to stably use up the ink while reducing the burden on the global environment.

### Second Embodiment

Next, a second embodiment will be described. Individual members in the second embodiment have the same configurations as those in the above-described first embodiment. Accordingly, these members will be denoted by the same reference signs as the respective members in the above-described first embodiment and will be explained accordingly. The ink container 10 according to the second embodiment is formed in the same way as the ink container 10 according to the first embodiment except that the ink inside the ink containing unit 11 is supplied to the ink ejection apparatus 100 by means of gas-liquid exchange.

### <Configuration of Ink Container>

The ink supply unit 16 of the second embodiment is provided with a communication hole (not shown) for gas-liquid exchange which communicates with the inside and the outside of the ink containing unit 11. In the ink container 10 according to the second embodiment, air is contained inside the ink containing unit 11, and the air flows into the ink containing unit 11 through the communication hole of the ink supply unit 16 along with the use and decrease of the ink contained inside the ink containing unit 11. The second embodiment focuses on adherence of the ink to the internal layer 32 of the film member 30 constituting the ink containing unit 11. The adherence of the ink to the internal layer 32 of the ink containing unit 11 (the film member 30) is determined by a relation between surface tension of the ink and surface tension (surface free energy) of the internal layer 32 of the ink containing unit 11. The internal layer 32 of the ink containing unit 11 tends to be more wettable as the surface tension of the internal layer 32 of the ink containing unit 11 is larger than the surface tension of the ink. In the case where the viscosity of the ink is higher, the ink tends to adhere more to the internal layer 32 of the ink containing unit 11 irrespective of the surface tension of the ink and of the internal layer 32 of the ink containing unit 11. Meanwhile, in the case where the temperature is higher, both the surface tension of the ink and the viscosity of the ink tend to be reduced. In the case where the surface tension of the ink is reduced by a rise in temperature, the ink is more likely to adhere to the internal layer 32 of the ink containing unit 11.

In the second embodiment, polyethylene is used as the olefin-based resin that constitutes the internal layer 32 as with the first embodiment. The viscosity of the ink contained inside the ink containing unit 11 is equal to or above 2 [mPa·s] and equal or below 3 [mPa·s]. Meanwhile, the surface tension of the ink is equal to or above 20 [mN/m] and equal to or below 45 [mN/m]. Here, the surface tension of the ink is measured by using the Wilhelmy method, for example. The inventor of the present application has found out that the use of the ink having the surface tension equal to or above 20 [mN/m] and equal to or below 45 [mN/m] makes it possible to stably use up the ink irrespective of the presence or absence of the air inside the ink containing unit 11 as compared to the ink having the surface tension equal to 70 [mN/m].

As described above, the second embodiment can provide the ink container 10 which makes it possible to stably use up the ink while reducing the burden on the global environment as with the first embodiment. Meanwhile, in the second embodiment, the surface tension of the ink contained inside the ink containing unit 11 is equal to or above 20 [mN/m] and equal to or below 45 [mN/m]. Thus, it is possible to stably use up the ink irrespective of the presence or absence of the air inside the ink containing unit 11.

In the first and second embodiments described above, the ink container 10 takes on the form of the spout pouch as shown in FIGS. 2A and 2B. However, the present invention is not limited to this configuration. For example, the ink container may take on a form of a so-called standing pouch. This configuration enables the ink container to stand up on its own. Here, in the case where the ink container takes on the form of the standing pouch, the ink container is formed into a shape of a gusseted bag provided with gussets at side portions.

### Third Embodiment

Next, a third embodiment will be described. Individual members in the third embodiment have the same configurations as those in the above-described first embodiment. Accordingly, these members will be denoted by the same reference signs as the respective members in the above-described first embodiment and will be explained accordingly. The ink container 10 according to the third embodiment is formed in the same way as the ink container 10 according to the first embodiment except the shape of the ink containing unit 11.

### <Configuration of Ink Container>

FIG. 4 is a schematic diagram showing the ink container 10 according to the third embodiment. As shown in FIG. 4, the ink containing unit 11 of the third embodiment is formed into a shape of a three-side seal bag by subjecting the film member 30 to the folding process and the welding process. Since the ink containing unit 11 is formed into the shape of the three-side seal bag, it is not necessary to form gussets as compared to the gusseted bag. Accordingly, it is possible to form the shapes of the welded portion 12 and the inner corner portions 14 easily, so that productivity of the ink container 10 can be enhanced. Meanwhile, since the shapes of the welded portion 12 and the inner corner portions 14 can be formed easily, it is possible to improve design freedom concerning the ink container 10 such as design freedom concerning the shapes of the inner corner portions 14 and design freedom concerning layout of the ink supply unit 16. For example, the inner corner portions 14 formed at four corners of the ink containing unit 11 and outer corner portions 17 formed at four corners of the welded portion 12 (the ink container 10) may be each formed into an arc shape. The outer corner portions 17 are easily kept from coming into contact with other components by forming a curvature radius RE of each outer corner portion 17 larger than a curvature radius RN of the inner corner portion 14.

In the ink container 10 according to the third embodiment, the ink containing unit 11 in the form of the bag is contracted in accordance with a decrease with use of the ink contained inside the ink containing unit 11 as with the first embodiment. Meanwhile, the air may flow into the ink containing unit 11 through the communication hole of the ink supply unit 16 in accordance with the decrease with use of the ink contained inside the ink containing unit 11 as with the second embodiment.

As described above, the third embodiment can provide the ink container 10 which makes it possible to stably use up the ink while reducing the burden on the global environment as with the first embodiment. Meanwhile, in the third embodiment, the ink containing unit 11 is formed into the shape of the three-side seal bag. Thus, it is possible to enhance productivity of the ink container 10 and the design freedom concerning the ink container 10.

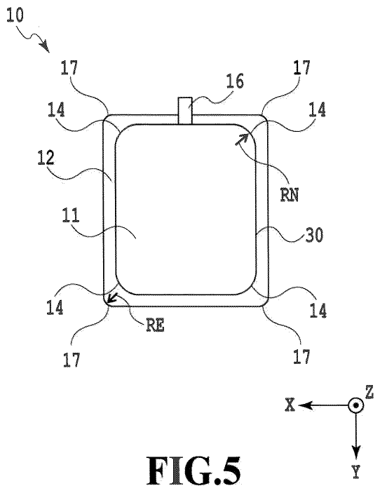

In the third embodiment described above, the curvature radius RE of the outer corner portion 17 is larger than the curvature radius RN of the inner corner portion 14. However, the present disclosure is not limited to this configuration. FIG. 5 is a schematic diagram showing a modified example of the ink container 10 according to the third embodiment. As shown in FIG. 5, the curvature radius RE of the outer corner portion 17 may be smaller than the curvature radius RN of the inner corner portion 14. In this case, a width of a portion between the inner corner portion 14 and the outer corner portion 17 at the welded portion 12 is increased, so that strength of the welded portion 12 can be enhanced.

### Fourth Embodiment

Next, a fourth embodiment will be described. Individual members in the fourth embodiment have the same configurations as those in the above-described first embodiment. Accordingly, these members will be denoted by the same reference signs as the respective members in the above-described first embodiment and will be explained accordingly. The ink container 10 according to the fourth embodiment is formed in the same way as the ink container 10 according to the first embodiment except the shape of the ink containing unit 11.

### <Configuration of Ink Container>

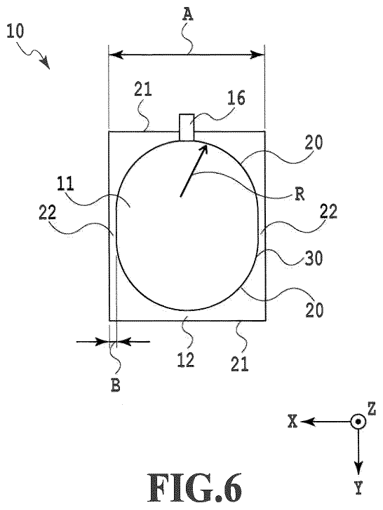

FIG. 6 is a schematic diagram showing the ink container 10 according to the fourth embodiment. As shown in FIG. 6, the ink containing unit 11 of the fourth embodiment is formed into the shape of the three-side seal bag by subjecting the film member 30 to the folding process and the welding process. As compared to the third embodiment, curved portions 20 constituting part of a borderline between the ink containing unit 11 and the welded portion 12 are formed at end portions on two sides in a longitudinal direction (the Y direction) of the ink containing unit 11 in the fourth embodiment. Accordingly, a stress to be applied to the welded portion 12 in a state where a large amount of the ink is contained inside the ink containing unit 11 can be relaxed, so that the ink containing unit 11 can be kept from being broken at the welded portion 12. Opposed portions 21 which are opposed to the curved portions 20 at an outer peripheral portion of the ink container 10 are each formed into a straight shape that extends in a short-side direction (the X direction) of the ink container 10. A curvature radium of each curved portion 20 varies with dimensions of the ink container 10. A maximum value of the curvature radius of the curved portion 20 is expressed by the following formula (1):

$$R = ( A - 2 B ) / 0.347 , \qquad ( 1 )$$

in which R is the maximum value of the curvature radius of the curved portion 20,
A is a length of the opposed portion 21 opposed to the curved portion 20 at the outer peripheral portion of the ink container 10, and
B is a width of an unopposed portion 22 of the welded portion 12 intersecting with the opposed portion 21.

Here, the length A of the opposed portion 21 is equivalent to a length of a portion at the outer peripheral portion of the ink container 10, which does not intersect with extensions of the curved portions 20. The width B of the unopposed portion 22 intersecting with the opposed portion 21 (orthogonal to the opposed portion 21 in the case of the present embodiment) is equivalent to a width of a portion of the welded portion 12 which intersects with an extension of the curved portion 20. In the present embodiment, the width B of the unopposed portion 22 is equivalent to a width of the unopposed portion 22 in a direction of extension of the opposed portion 21, or in other words, a width of the unopposed portion 22 in the short-side direction (the X direction) of the ink container 10. Satisfaction of the formula (1) makes it possible to relax the stress applied to the welded portion 12 in the state where the ink is contained inside the ink containing unit 11, and thus to prevent breakage of the ink containing unit 11 at the welded portion 12.

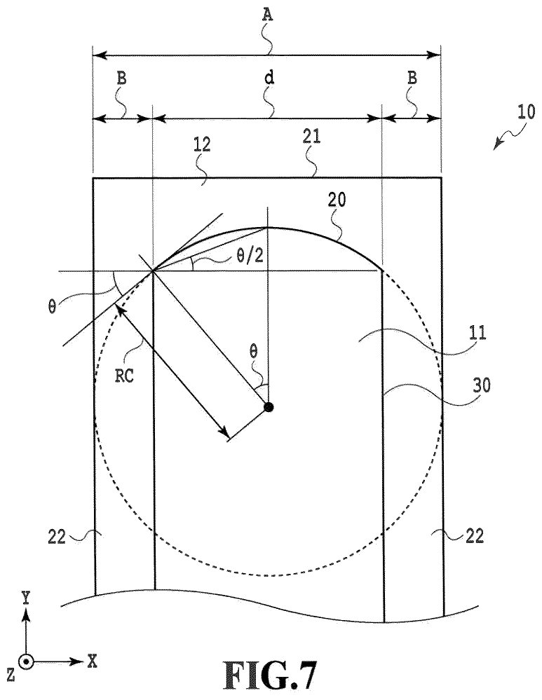

FIG. 7 is an explanatory diagram to explain a maximum value of the curvature radius of the curved portion 20. As shown in FIG. 7, the curvature radius of the curved portion 20 is defined as RC. A length of a segment (a chord) that passes through end portions on two sides of the curved portion 20 is defined as d. An angle of inclination of a tangent at an end portion of the curved portion 20 to the straight line that pass through end portions on two sides of the curved portion 20 is defined as 0. In this case, as shown in FIG. 7, a formula expressed as d=A−2B holds true. In the meantime, a formula expressed as RC=d/(2 sin θ)=(A−2B)/(2 sin θ) holds true. The curvature radius RC of the curved portion 20 reaches the minimum in the case where θ=90°. The inventor of the present disclosure has set θ=10° as a condition to maximize the curvature radius RC of the curved portion 20. Note that a formula expressed as 2 sin(10°)=0.347 holds true. Accordingly, a maximum value R of the curvature radius of the curved portion 20 is expressed by the aforementioned formula (1).

In the ink container 10 according to the fourth embodiment, the ink containing unit 11 in the form of the bag is contracted in accordance with a decrease with use of the ink contained inside the ink containing unit 11 as with the first embodiment. Meanwhile, the air may flow into the ink containing unit 11 through the communication hole of the ink supply unit 16 in accordance with the decrease with use of the ink contained inside the ink containing unit 11 as with the second embodiment.

As described above, the fourth embodiment can provide the ink container 10 which makes it possible to stably use up the ink while reducing the burden on the global environment as with the first embodiment. Meanwhile, in the fourth embodiment, the ink containing unit 11 is formed into the shape of the three-side seal bag. Thus, it is possible to enhance productivity of the ink container 10 and the design freedom concerning the ink container 10. In the meantime, the maximum value of the curvature radius of the curved portion 20 that constitutes the borderline between the ink containing unit 11 and the welded portion 12 is expressed by the aforementioned formula (1). Accordingly, the stress to be applied to the welded portion 12 in the state where a large amount of the ink is contained inside the ink containing unit 11 can be relaxed, so that the ink containing unit 11 can be kept from being broken at the welded portion 12.

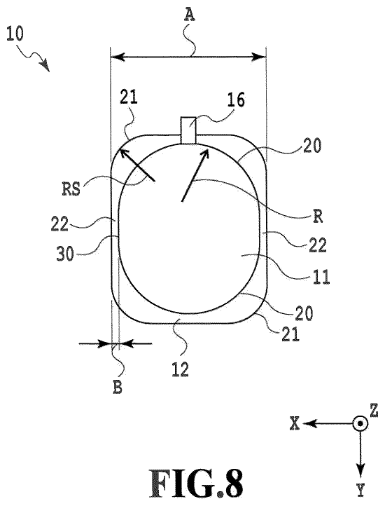

In the above-described fourth embodiment, the curved portions 20 constituting part of the borderline between the ink containing unit 11 and the welded portion 12 are formed at the end portions on two sides in the longitudinal direction (the Y direction) of the ink containing unit 11. However, the present disclosure is not limited to this configuration. FIG. 8 is a schematic diagram showing a first modified example of the ink container 10 according to the fourth embodiment. As shown in FIG. 8, each opposed portion 21 located at the outer peripheral portion of the ink container 10 and opposed to the corresponding curved portion 20 may be formed into a curved shape. Here, the opposed portions 21 may be formed into curved shapes at four corners of the ink container 10. The curvature radius of each curved portion 20 (the maximum value R) may be larger than a curvature radius RS of each opposed portion 21 formed into the curved shape. This configuration can also obtain similar effects to those of the above-described fourth embodiment.

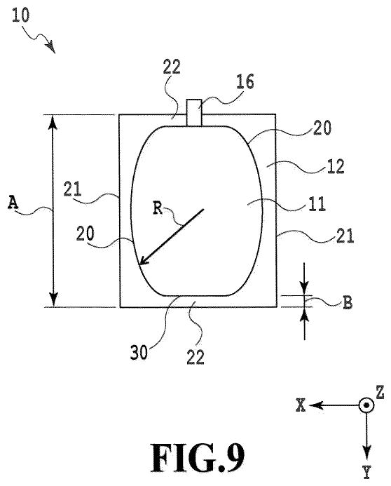

FIG. 9 is a schematic diagram showing a second modified example of the ink container 10 according to the fourth embodiment. As shown in FIG. 9, the curved portions 20 constituting part of the borderline between the ink containing unit 11 and the welded portion 12 may be formed at end portions on two sides in the short-side direction (the X direction) of the ink containing unit 11. The opposed portions 21 which are opposed to the curved portions 20 at the outer peripheral portion of the ink container 10 are each formed into a straight shape that extends in the longitudinal direction (the Y direction) of the ink container 10. The maximum value R of the curvature radius of each curved portion 20 is expressed by the formula (1) mentioned above. In the second modified example, the width B of the unopposed portion 22 intersecting with the opposed portion 21 is equivalent to a width of the unopposed portion 22 in the direction of extension of the opposed portion 21, or in other words, the width of the unopposed portion 22 in the longitudinal direction (the Y direction) of the ink container 10. This configuration can also obtain similar effects to those of the above-described fourth embodiment.

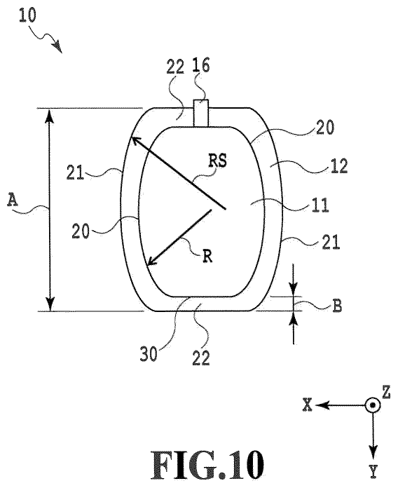

FIG. 10 is a schematic diagram showing a third modified example of the ink container 10 according to the fourth embodiment. As shown in FIG. 10, the curved portions 20 may be formed at the end portions on two sides in the short-side direction (the X direction) of the ink containing unit 11 as with the second modified example. The opposed portions 21 which are opposed to the curved portions 20 at the outer peripheral portion of the ink container 10 may each be formed into a curved shape. The curvature radius (the maximum value R) of each curved portion 20 may be smaller than the curvature radius RS of each opposed portion 21 formed into the curved shape. This configuration can also obtain similar effects to those of the above-described fourth embodiment.

In the respective embodiments described above, polyethylene is used as the olefin-based resin that constitutes the internal layer 32. However, the present disclosure is not limited to this configuration. For example, polypropylene may be used as the olefin-based resin that constitutes the internal layer 32.

Meanwhile, the ink container 10 according to each of the second to fourth embodiments is detachably attached to the ink supply unit 105 of the ink ejection apparatus 100. However, the present disclosure is not limited to this configuration. The ink container 10 according to each of the second to fourth embodiments may be used in an ink ejection apparatus provided with ink tanks. In this case, the ink contained inside the ink containing unit 11 may be poured from the ink supply unit 16 into the corresponding ink tank.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

According to the present disclosure, an ink container can be provided which makes it possible to stably use up an ink while reducing a burden on the global environment.

This application claims the benefit of Japanese Patent Application No. 2024-176514, filed Oct. 8, 2024, which is hereby incorporated by reference herein in its entirety.

What is claimed is:

1. An ink container comprising:
an ink containing unit provided with flexibility so as to be able to contain an ink inside; and
an ink supply unit configured to supply the ink contained inside the ink containing unit to outside, wherein
the ink containing unit is formed by using a film member having breaking elongation equal to or above 1%,
the film member includes
an internal layer being formed by using an olefin-based resin, and surrounding the inside of the ink container unit, and
an external layer formed on an outer side of the internal layer by using paper,
a viscosity of the ink contained inside the ink containing unit is equal to or above 2 (mPa·s) and equal to or below 3 (mPa·s), and
a weight ratio of the paper of the external layer relative to the ink container is equal to or above 50%.

2. The ink container according to claim 1, wherein a thickness of the external layer is equal to or above 50 (μm).

3. The ink container according to claim 1, wherein a thickness of the internal layer is equal to or above 10 (μm).

4. The ink container according to claim 1, wherein surface tension of the ink contained inside the ink containing unit is equal to or above 20 (mN/m) and equal to or below 45 (mN/m).

5. The ink container according to claim 1, wherein the olefin-based resin is polyethylene.

6. The ink container according to claim 1, wherein the ink containing unit is formed into a shape of a gusseted bag by using the film member.

7. The ink container according to claim 1, wherein the ink containing unit is formed into a shape of a three-side seal bag by using the film member.

8. The ink container according to claim 7, further comprising:
a welded portion located on an outer peripheral side of the ink containing unit and formed by welding the film members to each other, wherein
a maximum value of a curvature radius of a curved portion constituting a borderline between the ink containing unit and the welded portion is expressed by an following below:
$$R = ( A - 2 B ) / 0.347 ,$$
in which R is the maximum value of the curvature radius of the curved portion,
A is a length of an opposed portion opposed to the curved portion at an outer peripheral portion of the ink container, and
B is a width of an unopposed portion of the welded portion intersecting with the opposed portion.

9. The ink container according to claim 7, further comprising:
a welded portion located on an outer peripheral side of the ink containing unit and formed by welding the film members to each other, wherein
a curvature radius of a curved portion constituting a borderline between the ink containing unit and the welded portion is smaller than a curvature radius of an opposed portion opposed to the curved portion at an outer peripheral portion of the ink container.

10. The ink container according to claim 7, further comprising:
a welded portion located on an outer peripheral side of the ink containing unit and formed by welding the film members to each other, wherein
a curvature radius of a curved portion constituting a borderline between the ink containing unit and the welded portion is larger than a curvature radius of an opposed portion opposed to the curved portion at an outer peripheral portion of the ink container.
